(19) United States
(12) Patent Application Publication
(10) Pub. No.: US 2024/0418914 A1
(43) Pub. Date: Dec. 19, 2024

(54) LIGHT DIFFRACTION ELEMENT UNIT, OPTICAL COMPUTING DEVICE, ASSEMBLING METHOD, AND MANUFACTURING METHOD

(71) Applicant: FUJIKURA LTD., Tokyo (JP)

(72) Inventors: Hiroyuki Kusaka, Tokyo (JP); Masahiro Kashiwagi, Tokyo (JP)

(73) Assignee: FUJIKURA LTD., Tokyo (JP)

(21) Appl. No.: 18/274,090

(22) PCT Filed: Nov. 9, 2021
(86) PCT No.: PCT/JP2021/041094

§ 371 Date: Jul. 25, 2023

(30) Foreign Application Priority Data
Feb. 5, 2021 (JP) 2021-017679

(51) Int. Cl. G02B 5/18

(52) U.S. Cl. CPC G02B 5/1847

(57) ABSTRACT

A light diffraction element unit includes a light diffraction element including a substrate having a first main surface and a second main surface and a light diffraction structure composed of microcells and disposed on the first main surface, a first light-transmissive coating layer that covers the first main surface, and a second light-transmissive coating layer that covers the second main surface. A shape of a main surface of the first light-transmissive coating layer and a shape of a main surfaces of the second light-transmissive coating layer are complementary to each other. The main surface of the first light-transmissive coating layer is disposed opposite one side of the substrate. The main surface of the second light-transmissive coating layer is disposed opposite another side of the substrate.

### BACKGROUND

### Technical Field

The present invention relates to: a light diffraction element unit including a light diffraction structure composed of a plurality of microcells; and an optical computing device including a plurality of such light diffraction element units. In addition, the present invention relates to a method for assembling such an optical computing device and a method for manufacturing such an optical computing device.

### Description of the Related Art

Known is a light diffraction element that includes a plurality of microcells each of which has an individually set thickness or refractive index and that includes a substrate having one main surface on which a light diffraction structure is formed, the light diffraction structure optically performing predetermined computing by causing mutual interference of light beams which have passed through the respective microcells. Note that, here, the term “microcell” refers to, for example, a cell having a cell size of less than 10 μm. In addition, the term “cell size” refers to a square root of an area of a cell.

An optical computing device in which the plurality of light diffraction elements are used advantageously operates faster and consumes lower power than does an electrical computing device in which a processor is used. Patent Literature 1 discloses an optical neural network having an input layer, an intermediate layer, and an output layer. The light diffraction element described above can be used as, for example, an intermediate layer of such an optical neural network.

### PATENT LITERATURE

Patent Literature 1: U.S. Pat. No. 7,847,225

Such a light diffraction structure which constitutes the light diffraction element as described above is a small structure, as is clear from the above described cell size. In addition, the light diffraction structure is required to: be formed by a light-transmissive material; and have cells each of which has a thickness that can be designed individually. Thus, the above-described light diffraction structure is often manufactured by optical molding with use of a photo-curable resin. A structure which is manufactured by optical molding and is made of a photo-curable resin and which is small as described above tends to lack a mechanical strength.

The light diffraction element as described above thus requires delicate handling and therefore is difficult to handle. In addition, since each of the light diffraction elements is difficult to handle, in an optical computing device including the plurality of light diffraction elements, it is unpractical for a user to change a combination of the light diffraction elements.

### SUMMARY

One or more embodiments provide: a light diffraction element unit that is easy to handle; and an optical computing device including a plurality of such light diffraction element units. In addition, one or more embodiments provide a method for assembling an optical computing device with use of easy-to-handle light diffraction element units and a method for manufacturing such an optical computing device.

A light diffraction element unit in accordance with one or more embodiments includes: a light diffraction element that includes a substrate having a first main surface and a second main surface, the light diffraction element being provided with a light diffraction structure which is composed of a plurality of microcells and which is formed on the first main surface; and a first coating layer (example of a first light-transmissive coating layer) that covers the first main surface and that is light-transmissive.

One or more embodiments make it possible to provide: a light diffraction element unit that is easy to handle; and an optical computing device including a plurality of such light diffraction element units. In addition, one or more embodiments make it possible to provide a method for assembling an optical computing device with use of light diffraction element units that are easy to handle and a method for manufacturing such an optical computing device.

### BRIEF DESCRIPTION OF THE DRAWINGS

FIG. 1 is a perspective view illustrating a light diffraction element unit in accordance with Example 1.

FIG. 2 is a cross-sectional view illustrating the light diffraction element unit illustrated in FIG. 1.

FIG. 3 is a cross-sectional view illustrating Variation 1 of the light diffraction element unit illustrated in FIG. 1.

FIG. 4 is a cross-sectional view illustrating Variation 2 of the light diffraction element unit illustrated in FIG. 1.

FIG. 5 is an exploded cross-sectional view illustrating an optical computing device in accordance with Example 2.

FIG. 6 is an exploded cross-sectional view illustrating a variation of the optical computing device illustrated in FIG. 5.

### DESCRIPTION OF THE EMBODIMENTS

### Example 1

### <Configuration of Light Diffraction Element Unit>

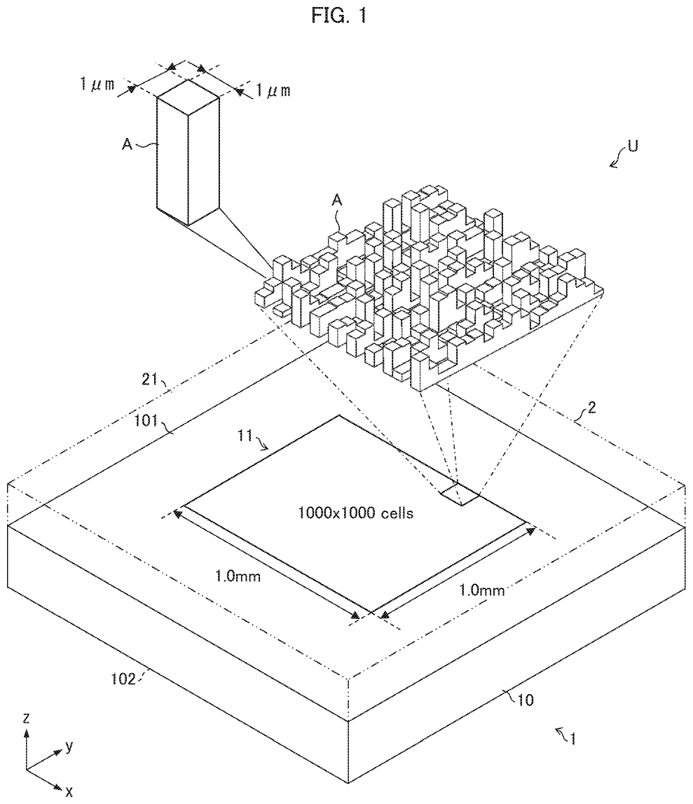

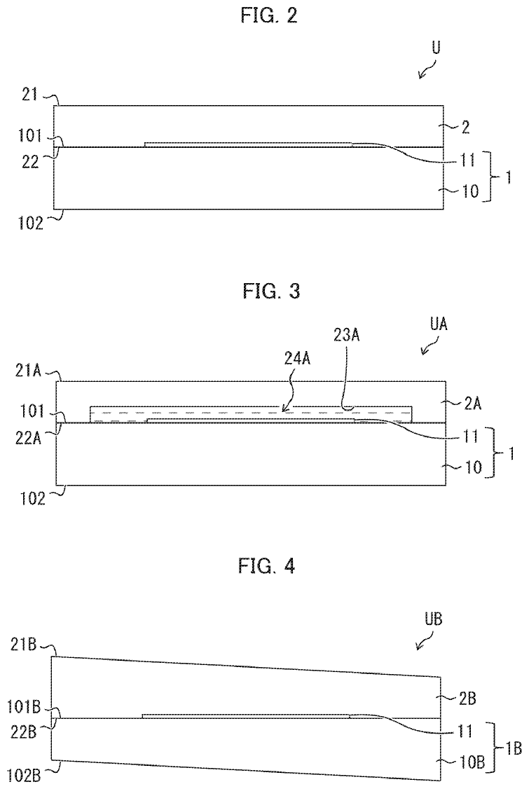

With reference to FIGS. 1 and 2, the following will describe a light diffraction element unit U in accordance with Example 1. FIG. 1 is a perspective view illustrating the light diffraction element unit U. FIG. 2 is a cross-sectional view illustrating the light diffraction element unit U. Note that, in FIG. 2, hatching is not used for clarity of the drawing.

As illustrated in FIG. 1, the light diffraction element unit U includes a light diffraction element 1 and a coating layer 2. Note that, in FIG. 2, the coating layer 2 is illustrated by virtual lines (dot-dot-dash lines).

### (Light Diffraction Element)

The light diffraction element 1 is a light-transmissive plate-like element. As illustrated in FIG. 1, the light diffraction element 1 includes a substrate 10 and a light diffraction structure 11.

The substrate 10 is a light-transmissive substrate having a main surface 101 and a main surface 102 which are located opposite to each other. The main surface 101 and the main surface 102 are respectively one example of a first main surface and one example of a second main surface of a light diffraction element and are flat and smooth surfaces. In Example 1, the main surface 102 is uncovered.

The substrate 10 has a thickness that is set such that a sum of the thickness of the substrate 10 and the thickness of the coating layer 2 described later is a desired thickness. In Example 1, the thickness of the substrate 10 is 30 μm. However, the thickness of the substrate 10 is not limited to this.

In Example 1, the substrate 10 is made of glass (for example, quartz glass). Note, however, that the substrate 10 may be made of resin (for example, photo-curable resin).

The light diffraction structure 11 is formed on the main surface 101. The light diffraction structure 11 is constituted by a plurality of microcells A having respective thicknesses or refractive indexes that are set independently of each other. In Example 1, each of the microcells A is made of a light-transmissive resin (for example, photo-curable resin). Alternatively, the light diffraction structure 11 may be made of glass (for example, quartz glass).

When signal light enters the light diffraction structure 11, the signal light beams that have passed through respective microcells A interfere with each other, so that a predetermined optical computing is performed. The intensity distribution of the signal light outputted from the light diffraction structure 11 shows the result of the optical computing.

Here, the term “microcell” means, for example, a cell having a cell size of less than 10 μm. The term “cell size” refers to a square root of an area of a cell. For example, in a case where a microcell has a square shape in plan view, the cell size is a length of one side of the cell. The cell size has a lower limit that is not particularly limited but may be, for example, 1 nm.

The light diffraction structure 11 illustrated as one example in an enlarged view in FIG. 1 is constituted by 1000×1000 microcells A arranged in a matrix manner. The shape of each of the microcells A in plan view is, for example, a square with a size of 1 um×1 um, and the shape of the light diffraction structure 11 in plan view is, for example, a square with a size of 1 mm×1 mm.

Note that the cell size, the shape in plan view of each of the microcells A, and the shape in plan view of the light diffraction structure 11 are not limited to the above-described examples, but can be set as appropriate.

### (Coating Layer)

As illustrated in FIG. 1, the coating layer 2 is a light-transmissive layer-shaped or plate-shaped member that has a main surface 21 and a main surface 22 which are located opposite to each other. The main surface 21 is one example of a main surface provided on an opposite side from the substrate, among a pair of main surfaces of a first coating layer and is a flat and smooth surface as in the case of the main surfaces 101 and 102.

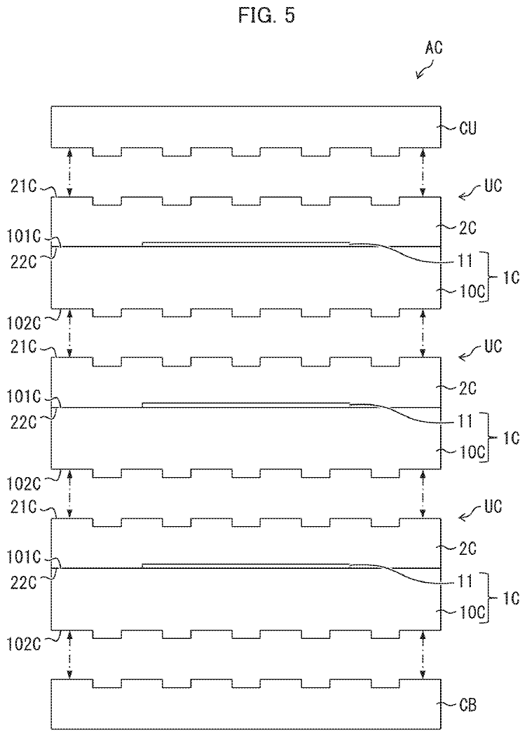

The coating layer 2 has a thickness that is set such that a sum of the thickness of the coating layer 2 and the thickness of the substrate 10 described above is a desired thickness. In Example 1, the coating layer 2 has a thickness of 10 μm. However, the thickness of the coating layer 2 is not limited to this. In a case where a plurality of light diffraction element units U each of which includes the substrate 10 having a thickness of 30 μm and the coating layer 2 having a thickness of 10 μm are stacked on top of each other (for example, in a case where the plurality of light diffraction element units U are stacked on top of each other as illustrated in FIG. 5 described later), it is possible to make a distance between respective light diffraction structures 11 of the light diffraction element units U adjacent to each other substantially identical to the sum of the thickness of the substrate 10 and the thickness of the coating layer 2. Therefore, it is possible to easily make the distance between the respective light diffraction structures 11 substantially identical to a desired value. Note that the above-described thicknesses of the substrate 10 and the coating layer 2 are set on the assumption that, as a wavelength A of signal light, λ=1.5 μm is employed, and, as a refractive index of a material of which each of the substrate 10 and the coating layer 2 is made, 1.5 is employed.

The coating layer 2 is formed on the main surface 101 such that the main surface 22 is in a direct contact with the main surface 101 of the substrate 10 and a surface of the light diffraction structure 11. The coating layer 2 covers the main surface 101 and the surface of the light diffraction structure 11. In Example 1, the light diffraction structure 11 is embedded in the coating layer 2.

In Example 1, the coating layer 2 is made of a light-transmissive resin (for example, photo-curable resin). Alternatively, the coating layer 2 may be made of glass (for example, quartz glass).

In Example 1, the main surface 21 is configured to be parallel to or substantially parallel to each of the main surface 101 and the main surface 102.

Both the main surface 21 and the main surface 102 are flat and smooth surfaces. Thus, the main surface 21 and the main surface 102 have shapes complementary to each other.

### <Variation 1>

With reference to FIG. 3, the following will describe a light diffraction element unit UA, which is Variation 1 of the light diffraction element unit U. FIG. 3 is a cross-sectional view illustrating the light diffraction element unit UA. Note that in FIG. 3, hatching is not used except for matching oil 24A, for clarity of the drawing.

As illustrated in FIG. 3, the light diffraction element unit UA can be achieved by replacing, with a coating layer 2A, the coating layer 2 included in the light diffraction element unit U illustrated in FIG. 2.

The coating layer 2A, like the coating layer 2, is a light-transmissive layer-shaped or plate-shaped member that has a main surface 21A and a main surface 22A which are located opposite to each other. Note, however, that the coating layer 2A differs from the coating layer 2 in that a recess 23A is formed on the main surface 22A, which is a main surface provided on a substrate 10 side, among a pair of main surfaces. The recess 23A is formed so as to include the light diffraction structure 11 in a case where the coating layer 2A is seen in plan view. Further, the recess 23A has a depth that exceeds the maximum value of a thickness of the light diffraction structure 11. Thus, in a case where the coating layer 2A is stacked on the main surface 101, the coating layer 2A is apart from the light diffraction structure 11, and the light diffraction structure 11 is accommodated in a space defined by the substrate 10 and the coating layer 2A.

In Example 1, the space between the substrate 10 and the coating layer 2A is filled with oil 24 that is light-transmissive. The oil 24 serves as matching oil for matching a refractive index of the light diffraction structure 11 with a refractive index of the coating layer 2A. Thus, the oil 24 has a refractive index that is set as appropriate depending on the refractive index of the light diffraction structure 11 and the refractive index of the coating layer 2A.

Note that a substance with which the above-described space is filled is not limited to oil such as the oil 24 but can be any substance that is light-transmissive. Such a substance may be, for example, a liquid, a gas, or a resin. Note that the substance preferably contains neither an oxygen molecule nor moisture whatever substance is selected from among a liquid, a gas, and a resin. Further, in a case where the substance is a gas, the gas may be composed of molecules of a single kind or may be composed of molecules of two or more kinds.

### <Variation 2>

With reference to FIG. 4, the following will describe a light diffraction element unit UB, which is Variation 2 of the light diffraction element unit U. FIG. 4 is a cross-sectional view illustrating the light diffraction element unit UB. Note that, in FIG. 4, hatching is not used for clarity of the drawing.

As illustrated in FIG. 4, the light diffraction element unit UB is based on the light diffraction element unit U illustrated in FIG. 2 and can be achieved by changing a tilt of a main surface 102B relative to a main surface 101B and a tilt of a main surface 21B relative to the main surface 101B. Specifically, in the light diffraction element unit U, the main surface 101 is parallel to the main surface 102 and is parallel to the main surface 21. That is, the main surface 101, the main surface 102, and the main surface 21 are parallel to each other. In contrast, in the light diffraction element unit UB, the main surface 102B is parallel to the main surface 21B but is not parallel to the main surface 101B, and the main surface 101B is not parallel to the main surface 21B.

The main surface 102B and the main surface 21B are parallel to each other, so that, even in a case where the plurality of light diffraction element units UB are stacked on top of each other (for example, even in a case where the plurality of light diffraction element units UB are stacked on top of each other as illustrated in FIG. 5 described later), respective main surfaces 101B of the light diffraction element units UB adjacent to each other are parallel to each other. Thus, it is possible to properly dispose the respective light diffraction structures 11 of the adjacent light diffraction element units UB. In addition, it is possible to easily make a distance between the respective light diffraction structures 11 of the adjacent light diffraction element units UB substantially identical to a desired value.

### Example 2

### <Configuration of Optical Computing Device>

With reference to FIG. 5, the following will describe an optical computing device AC in accordance with Example 2. FIG. 5 is an exploded cross-sectional view illustrating the optical computing device AC. Note that, in FIG. 5, hatching is not used for clarity of the drawing.

As illustrated in FIG. 5, the optical computing device AC includes three light diffraction element units UC, a cover CU, and a cover CB.

### (Light Diffraction Element Unit)

The light diffraction element unit UC is Variation 3 of the light diffraction element unit U illustrated in FIG. 2. The light diffraction element unit UC includes a light diffraction structure 11 that is configured to be identical to the light diffraction structure 11 that is included in the light diffraction element unit U. In addition, the light diffraction element unit UC includes a substrate 10C and a coating layer 2C that are achieved respectively by changing a shape of the main surface 102 of the substrate 10 included in the light diffraction element unit U and by changing a shape of the main surface 21 of the coating layer 2 included in the light diffraction element unit U. Note that, as in the case of the light diffraction element unit U, in the single light diffraction element unit UC, a main surface 102C is uncovered.

The main surface 102C is provided with a plurality of (five in FIG. 5) protrusions each having a rectangular cross section. Note that each of the protrusions may be a strip-shaped protrusion that extends along a depth direction in FIG. 5. Further, each of the protrusions may be constituted by a plurality of sub-protrusions apart from each other when seen along the depth direction in FIG. 5.

A main surface 21C is, so as to have a shape complementary to that of the main surface 102C, provided with a plurality of (five in FIG. 5) recesses each having a rectangular cross section.

As such, each of the protrusions provided on the main surface 102C and each of the recesses provided on the main surface 21C have shapes complementary to each other. This configuration allows, in a case where the plurality of light diffraction element units UC are stacked on top of each other as illustrated in FIG. 5, the main surface 102C and the main surface 21C in the light diffraction element units UC adjacent to each other to be in contact with each other such that no or little gap is generated at an interface between the main surface 102C and the main surface 21C.

### (Cover)

Each of the cover CU and the cover CB is configured to cover each of a pair of main surfaces of the optical computing device AC. In a state illustrated in FIG. 5, the cover CU serves as a top cover, and the cover CB serves as a bottom cover.

Among main surfaces of the cover CU, a main surface on a light diffraction element unit UC side (a main surface on a lower side in FIG. 5) is, so as to have a shape complementary to that of the main surface 21C, provided with a plurality of (five in FIG. 5) protrusions each having a rectangular cross section. The plurality of protrusions provided on the cover CU each have the same shape as that of each of the plurality of protrusions provided on the main surface 102C. Note that, among the main surfaces of the cover CU, a main surface on a reverse side from the light diffraction element unit UC is a flat and smooth surface.

Among main surfaces of the cover CB, a main surface on a light diffraction element unit UC side (a main surface on an upper side in FIG. 5) is provided with a plurality of (five in FIG. 5) recesses each having a rectangular cross section. The plurality of recesses provided on the cover CB each have the same shape as that of each of the plurality of recesses provided on the main surface 21C. Note that, among the main surfaces of the cover CB, a main surface on a reverse side from the light diffraction element unit UC is a flat and smooth surface.

The optical computing device AC includes the cover CU and the cover CB, so that both of the pair of the main surfaces that serve as an incident surface and an emission surface are flat and smooth surfaces.

### (Fixation of Light Diffraction Element Units UC)

In the light diffraction element units UC, the light diffraction element units UC adjacent to each other may be fixed to each other with use of a bonding layer described later or may not be fixed to each other. In a case where the adjacent light diffraction element units UC are fixed to each other, it is possible to prevent displacement of each of the light diffraction structures 11. In contrast, in a case where the adjacent light diffraction element units UC are not fixed to each other, it is possible to freely change a combination of the plurality of light diffraction element units UC that constitute the optical computing device AC.

In the light diffraction element unit UC, a configuration is employed in which a sum of a thickness of the substrate 10C and a thickness of the coating layer 2C is a desired value. This makes it possible to easily make a distance between respective light diffraction structures 11 of the adjacent light diffraction element units UC substantially identical to the desired value.

Further, in a case where the adjacent light diffraction element units UC are not fixed to each other with use of an adhesive, the light diffraction element units UC are fixed to each other with use of optionally fixing means that can be optionally switched to a fixing mode or an unfixing mode. The optionally fixing means may be a guide that is provided with grooves which are cut so as to each have the same width as that of each of the light diffraction element units UC or may be a case that can accommodate the plurality of light diffraction element units UC in a stacked state.

Further, the above-described guide or case may include a stopper in which a flat spring is used. For example, in a case where the optionally fixing means is a stopper, it is sufficient that a flat spring is interposed between the cover CU of the optical computing device AC and a top lid of the case. When the top lid of the case is closed in a state where the optical computing device AC is accommodated, a force with which the optical computing device AC is held acts on the light diffraction element units UC stacked on top of each other along a direction normal to the main surface 101C. The force is generated by the flat spring. This makes it possible to keep a position of each of the light diffraction element units UC and positions of the covers CU and CB in the optical computing device AC. Further, according to such a configuration, opening the top lid of the case stops the action of the force with which the optical computing device AC is held and thus makes it possible to change a combination of the light diffraction element units UC.

Alternatively, a configuration may be employed in which only one cover (for example, the cover CB) is fixed to the case with use of an adhesive in advance, and, on that cover, the plurality of light diffraction element units UC are stacked.

Further, in a case where the main surfaces 21C and 102C of each of the light diffraction element units UC are flat and smooth surfaces (see, for example, FIGS. 2 to 4), each of the covers CU and CB may be fixed to the case with use of an adhesive in advance. The distance between the cover CU and the cover CB needs only be set in advance as appropriate depending on the number of the light diffraction element units UC to be stacked on top of each other. This configuration makes it possible to change a combination of the light diffraction element units UC.

### <Assembling Method and Manufacturing Method>

One or more embodiments also include a method for assembling the optical computing device AC including the plurality of light diffraction element units UC and a method for manufacturing the optical computing device AC. The assembling method is a method in which the light diffraction element units UC are shipped independently of each other from a factory, and a user assembles the light diffraction element units UC, so that the optical computing device AC is obtained. The manufacturing method is a method in which the optical computing device AC is manufactured in a factory.

When the present assembling method is performed by a user, the user can assemble the optical computing device AC by selecting a plurality of light diffraction element units UC that can perform a desired optical computing and combining the plurality of light diffraction element units UC selected.

Adjacent two of the three light diffraction element units UC illustrated in FIG. 5 are one example of a first light diffraction element unit and one example of a second light diffraction element unit. In Example 2, lower, middle, and upper light diffraction element units UC illustrated in FIG. 5 are a first light diffraction element unit, a second light diffraction element unit, and a third light diffraction element unit, respectively. Note that the number of the light diffraction element units UC that constitute the optical computing device AC is not limited to three, but can be any number that is two or more.

Each of the present assembling method and the present manufacturing method includes a step of bringing the main surface 21C of the lower light diffraction element unit UC illustrated in FIG. 5 and the main surface 102C of the middle light diffraction element unit UC illustrated in FIG. 5 into contact with each other.

Note that, in this step, the main surface 21C and the main surface 102C to be brought into contact with each other may be fixed to each other with use of a light-transmissive bonding layer. That is, the main surface 21C and the main surface 102C may be in contact with each other via a bonding layer. Examples of a material that forms such a bonding layer include a light-transmissive resin (for example, photo-curable resin).

Each of the present assembling method and the present manufacturing method further includes: a step of bringing a main surface of the cover CB on a light diffraction element unit UC side and the main surface 102C of the lower light diffraction element unit UC illustrated in FIG. 5 into contact with each other; a step of bringing the main surface 21C of the middle light diffraction element unit UC illustrated in FIG. 5 and the main surface 102C of the upper light diffraction element unit UC illustrated in FIG. 5 into contact with each other; and a step of bringing the main surface 21C of the upper light diffraction element unit UC illustrated in FIG. 5 and a main surface of the cover CU on a light diffraction element unit UC side into contact with each other. The dot-and-dash arrows illustrated in FIG. 5 indicate these steps.

In Example 2, the optical computing device AC is configured with use of the plurality of light diffraction element units UC. Note, however, that each light diffraction element unit that constitutes the optical computing device AC in accordance with one or more embodiments is not limited to the light diffraction element unit UC, and need only be any light diffraction element unit in accordance with one or more embodiments (see, for example, FIGS. 1 to 4).

### <Variation>

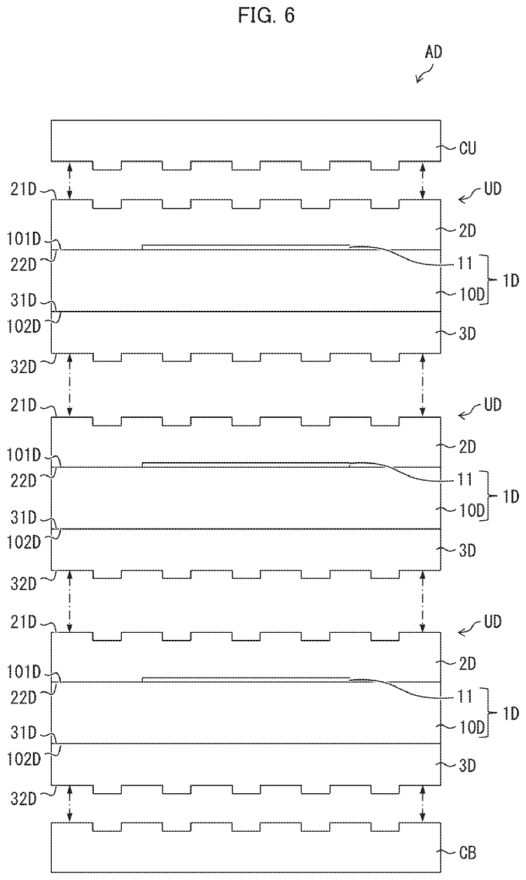

With reference to FIG. 6, the following will describe an optical computing device AD, which is a variation of the optical computing device AC. FIG. 6 is an exploded cross-sectional view illustrating the optical computing device AD. Note that, in FIG. 6, hatching is not used for clarity of the drawing.

The optical computing device AD is based on the optical computing device AC and can be achieved by replacing each of the light diffraction element units UC with a light diffraction element unit UD. The light diffraction element unit UD is Variation 4 of the light diffraction element unit U illustrated in FIG. 2.

The light diffraction element unit UD includes a coating layer 3D in addition to a light diffraction element 1D and a coating layer 2D. The light diffraction element 1D and the coating layer 2D correspond respectively to the light diffraction element 1 and the coating layer 2 of the light diffraction element unit U. The coating layer 3D is one example of a second coating layer.

The coating layer 3D is a light-transmissive layer-shaped or plate-shaped member that has a main surface 31D and a main surface 32D which are located opposite to each other. The main surface 32D is one example of a main surface provided on an opposite side from a substrate, among a pair of main surfaces of the second coating layer.

The coating layer 3D has a thickness that is set such that a sum of thicknesses of a substrate 10D, the coating layer 2D, and the coating layer 3D is a desired thickness.

The main surface 32D is provided with a plurality of (five in FIG. 6) protrusions each having a rectangular cross section. These plurality of protrusions are configured to be identical to the plurality of protrusions provided on the main surface 102C in the light diffraction element unit UC illustrated in FIG. 5.

A main surface 21D is, so as to have a shape complementary to that of the main surface 32D, provided with a plurality of (five in FIG. 6) recesses each having a rectangular cross section. These plurality of recesses are configured to be identical to the plurality of recesses provided on the main surface 21C in the light diffraction element unit UC illustrated in FIG. 5

As such, each of the protrusions provided on the main surface 32D and each of the recesses provided on the main surface 21D have shapes complementary to each other. This configuration allows, in a case where the plurality of light diffraction element units UC are stacked on top of each other as illustrated in FIG. 6, the main surface 32D and the main surface 21D in the light diffraction element units UD adjacent to each other to be in contact with each other such that no or little gap is generated at an interface between the main surface 32D and the main surface 21D.

To the present assembling method and the present manufacturing method, an assembling method and a manufacturing method similar to those for the optical computing device AC can be applied.

Each of the method for assembling and the method for manufacturing the optical computing device AD includes a step of bringing the main surface 21D of the lower light diffraction element unit UD illustrated in FIG. 6 and the main surface 32D of the middle light diffraction element unit UD illustrated in FIG. 6 into contact with each other. This step may be configured to fix the main surface 21D and the main surface 32D to each other with use of a light-transmissive bonding layer.

Each of the present assembling method and the present manufacturing method further includes: a step of bringing a main surface of the cover CB on a light diffraction element unit UD side and the main surface 32D of the lower light diffraction element unit UD illustrated in FIG. 6 into contact with each other; a step of bringing the main surface 21D of the middle light diffraction element unit UD illustrated in FIG. 6 and the main surface 32D of the upper light diffraction element unit UD illustrated in FIG. 6 into contact with each other; and a step of bringing the main surface 21D of the upper light diffraction element unit UD illustrated in FIG. 6 and a main surface of the cover CU on a light diffraction element unit UD side into contact with each other. The dot-and-dash arrows illustrated in FIG. 6 indicate these steps. Aspects of one or more embodiments can also be expressed as follows:

A light diffraction element unit in accordance with Aspect 1 of one or more embodiments includes: a light diffraction element that includes a substrate having a first main surface and a second main surface, the light diffraction element being provided with a light diffraction structure which is composed of a plurality of microcells and which is formed on the first main surface; and a first coating layer that covers the first main surface and that is light-transmissive.

According to the above configuration, the light diffraction structure is, together with the first main surface, covered with the first coating layer. This makes it possible to protect the light diffraction structure from a pressure, an impact and the like which may be applied from an outside. Therefore, the light diffraction element unit makes it possible to improve handleability thereof.

Further, a light diffraction element unit in accordance with Aspect 2 of one or more embodiments employs, in addition to the configuration of the light diffraction element unit in accordance with Aspect 1 described above, a configuration such that the light diffraction structure is embedded in the first coating layer.

According to the above configuration, the first coating layer blocks a contact between the light diffraction structure and air. This makes it possible to prevent adhesion of a foreign matter such as dust to the light diffraction structure. Further, the first coating layer blocks a contact between: the light diffraction structure; and an oxygen particle and moisture contained in air. This makes it possible to prevent deterioration in the light diffraction structure.

Further, a light diffraction element unit in accordance with Aspect 3 of one or more embodiments employs, in addition to the configuration of the light diffraction element unit in accordance with Aspect 1 described above, a configuration such that the first coating layer is apart from the light diffraction structure.

According to the above configuration, merely placing a coating which has been prepared in advance in another step can manufacture the light diffraction element unit. Thus, the light diffraction element unit can be manufactured easily compared with the light diffraction element unit in accordance with Aspect 2 described above.

Further, a light diffraction element unit in accordance with Aspect 4 of one or more embodiments employs, in addition to the configuration of the light diffraction element unit in accordance with Aspect 3 described above, a configuration such that a space between the first coating layer and the light diffraction structure is filled with a substance selected from the group consisting of a liquid, a gas, and a resin

According to the above configuration, a space around the light diffraction structure is filled with a substance selected from the group consisting of a liquid, a gas, and a resin. This makes it possible to block contact between the light diffraction structure and air that is present outside the light diffraction element unit. Thus, it is possible to prevent adhesion of a foreign matter such as dust to the light diffraction structure. Further, in a case where the substance selected from the group consisting of a liquid, a gas, and a resin with which the space is filled contains neither oxygen molecules nor moisture, contact is blocked between: the light diffraction structure; and oxygen molecules and moisture contained in air. Thus, the light diffraction element unit makes it possible to prevent deterioration in the light diffraction structure.

Further, a light diffraction element unit in accordance with Aspect 5 of one or more embodiments employs, in addition to the configuration of the light diffraction element unit in accordance with any one of Aspects 1 to 4, a configuration to further include a second coating layer (example of a second light-transmissive coating layer) that covers the second main surface and that is light-transmissive, wherein a shape of a main surface provided on an opposite side from the substrate, among a pair of main surfaces of the first coating layer, and a shape of a main surface provided on an opposite side from the substrate, among a pair of main surfaces of the second coating layer, are complementary to each other.

Further, a light diffraction element unit in accordance with Aspect 6 of one or more embodiments employs, in addition to the configuration of the light diffraction element unit in accordance with any one of Aspects 1 to 4, a configuration such that the second main surface is uncovered, and a shape of a main surface provided on an opposite side from the substrate, among a pair of main surfaces of the first coating layer, and a shape of the second main surface are complementary to each other.

According to the light diffraction element unit in accordance with Aspect 5 of one or more embodiments, in a case where an optical computing device is configured with use of at least two light diffraction element units, it is possible to bring a main surface provided on an opposite side from the substrate, among a pair of main surfaces of the first coating layer and a main surface provided on an opposite side from the substrate, among a pair of main surfaces of the second coating layer into contact with each other with no gap. In addition, according to the light diffraction element unit in accordance with Aspect 6 of one or more embodiments, in a case where an optical computing device is configured with use of at least two light diffraction element units, it is possible to bring a main surface provided on an opposite side from the substrate, among a pair of the main surfaces of the first coating layer, and the second main surface into contact with each other with no gap. Therefore, it is possible to reduce return loss which may occur in the interface between these main surfaces.

An optical computing device in accordance with Aspect 7 of one or more embodiments includes at least first and second light diffraction element units each of which is the light diffraction element unit in accordance with any one of Aspects 1 to 6 described above, wherein a main surface provided on an opposite side from the substrate, among a pair of main surfaces of the first coating layer of the first light diffraction element unit, is in contact with the second main surface of the second light diffraction element unit or a main surface provided on an opposite side from the substrate, among a pair of main surfaces of the second coating layer that covers the second main surface.

An optical computing device in accordance with Aspect 7 of one or more embodiments includes the light diffraction element units each of which is in accordance with one or more embodiments. Thus, in the optical computing device, it is possible to easily handle the light diffraction element units. This makes it possible to easily assemble and manufacture the optical computing device.

Further, according to the above configuration, setting a thickness (a sum of a thickness of the substrate and a thickness of the first coating layer or a sum of thicknesses of: the substrate; the first coating layer; and the second coating layer) of the light diffraction element unit to a desired value in advance makes is possible to, in a case where an optical computing device is configured by stacking a plurality of light diffraction element units on top of each other, make a distance between the adjacent light diffraction structures substantially identical to the desired value. Thus, the optical computing device is suitable for configuring a light diffraction element unit which allows a combination of a plurality of light diffraction element units to be easily changed.

An assembling method in accordance with Aspect 8 of one or more embodiments is a method for assembling an optical computing device including at least first and second light diffraction element units each of which is the light diffraction element unit in accordance with any one of Aspects 1 to 6 described above, the method including the step of bringing a main surface provided on an opposite side from the substrate, among a pair of main surfaces of the first coating layer of the first light diffraction element unit into contact with the second main surface of the second light diffraction element unit or a main surface provided on an opposite side from the substrate, among a pair of main surfaces of the second coating layer that covers the second main surface.

A manufacturing method in accordance with Aspect 9 of one or more embodiments is a method for manufacturing an optical computing device including at least first and second light diffraction element units each of which is the light diffraction element unit in accordance with any one of Aspects 1 to 6 described above, the method including the step of bringing a main surface provided on an opposite side from the substrate, among a pair of main surfaces of the first coating layer of the first light diffraction element unit into contact with the second main surface of the second light diffraction element unit or a main surface provided on an opposite side from the substrate, among a pair of main surfaces of the second coating layer that covers the second main surface.

Each of the assembling method in accordance with Aspect 8of one or more embodiments and the manufacturing method in accordance with Aspect 9 of one or more embodiments involves the light diffraction element unit in accordance with one or more embodiments. Thus, in the present assembling method and the present manufacturing method, it is possible to easily handle the light diffraction element units in a case where light diffraction element units are assembled or manufactured. Therefore, the assembling method and the manufacturing method make it possible to easily assemble and manufacture an optical computing device.

### Additional Remarks

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

AC, AD Optical computing device
U, UA, UB, UC, UD Light diffraction element unit
1, 1A, 1B, 1C, 1D Light diffraction element
10, 10B, 10C, 10D Substrate
101, 102, 101B, 102B, 101C, 102C, 101D, 102D Main surface
11 Light diffraction structure
2, 2A, 2B, 2C, 2D Coating layer
21, 22, 21A, 22A, 21B, 22B, 21C, 22C, 21D, 22D Main surface

1. A light diffraction element unit comprising:
a light diffraction element including:
a substrate having a first main surface and a second main surface; and
a light diffraction structure composed of microcells and disposed on the first main surface;
a first light-transmissive coating layer that covers the first main surface; and
a second light-transmissive coating layer that covers the second main surface, wherein
a shape of a main surface of the first light-transmissive coating layer and a shape of a main surfaces of the second light-transmissive coating layer are complementary to each other,
the main surface of the first light-transmissive coating layer is disposed opposite one side of the substrate, and
the main surface of the second light-transmissive coating layer is disposed opposite another side of the substrate.

2. The light diffraction element unit according to claim 1, wherein the light diffraction structure is embedded in the first light-transmissive coating layer.

3. The light diffraction element unit according to claim 1, wherein the first light-transmissive coating layer is apart from the light diffraction structure.

4. The light diffraction element unit according to claim 3, wherein a space between the first light-transmissive coating layer and the light diffraction structure is filled with one of a liquid, a gas, and a resin.

5. (canceled)

6. A light diffraction element unit comprising:
a light diffraction element including:
a substrate having a first main surface and a second main surface;
a light diffraction structure composed of microcells and disposed on the first main surface; and
a light-transmissive coating layer that covers the first main surface, wherein
the second main surface is uncovered,
a shape of a main surface of the light-transmissive coating layer and a shape of the second main surface are complementary to each other, and
the main surface of the light-transmissive coating layer is disposed opposite one side of the substrate.

7. An optical computing device comprising:
first and second light diffraction element units, each of which is the light diffraction element unit according to claim 1, wherein
the main surface of the first light-transmissive coating layer of the first light diffraction element unit contacts either:
the second main surface of the second light diffraction element unit, or
the main surface of the second light-transmissive coating layer of the second light diffraction element unit.

8. A method for assembling an optical computing device including first and second light diffraction element units, each of which is the light diffraction element unit according to claim 1, the method comprising:
causing the main surface of the first light-transmissive coating layer of the first light diffraction element unit to contact either:
the second main surface of the second light diffraction element unit, or
the main surface of the second light-transmissive coating layer of the second light diffraction element unit.

9. A method for manufacturing an optical computing device including first and second light diffraction element units, each of which is the light diffraction element unit according to claim 1, the method comprising:
bringing a causing the main surface of the first light-transmissive coating layer of the first light diffraction element unit to contact either:
the second main surface of the second light diffraction element unit, or
the main surface of the second light-transmissive coating layer of the second light diffraction element unit.

10. The light diffraction element unit according to claim 1, wherein
the main surface of the first light-transmissive coating layer has recesses, and
the main surface of the second light-transmissive coating layer has protrusions.

11. The light diffraction element unit according to claim 6, wherein
the main surface of the first coating layer has recesses, and
the second main surface has protrusions.
